(19) United States
(12) Patent Application Publication
(10) Pub. No.: US 2002/0019947 A1
(43) Pub. Date: Feb. 14, 2002

(54) Discernment information input apparatus

(75) Inventors: Megumi Umezawa, Kawasaki-shi (JP); Kazuhisa Tsuzuki, Fort Lee, NJ (US); Mamoru Higashimura, Yokohama-shi (JP); Motohiro Misawa, Yokohama-shi (JP); Jun Ebisawa, Yokohama-shi (JP); Kazuya Matsumoto, Tokyo (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 09/917,986

(22) Filed: Jul. 30, 2001

(30) Foreign Application Priority Data
Jul. 31, 2000 (JP) 2000-231601

(51) Int. Cl. G06F 3/02

(52) U.S. Cl. 713/202; 708/135

(57) ABSTRACT

The identification information input apparatus comprises a rotary encoder group for giving the user a click feel per unit rotation and generating an electric signal, and inputting arbitrary alphanumeric characters forming alphanumeric characters assigned in proportion to rotation angle via rotating operation, a pushbutton switch group for confirming alphanumeric characters input via the dial unit, password conversion unit for converting the electric signal generated by the dial unit to the alphanumeric characters based on a conversion table, and password authentication unit for authenticating the converted alphanumeric characters by checking whether the alphanumeric characters converted by the conversion unit are alphanumeric characters constituting the password.

### BACKGROUND OF THE INVENTION

The present invention relates to identification information input apparatus for inputting identification information such as a password necessary for authenticating the user of apparatus.

In recent years, a method of requesting input of identification information has been employed in order to authenticate the user of apparatus in a variety of apparatus. For example, in a terminal that assumes a multi-user environment, input of identification information such as a user ID and password is requested before use in order to avoid unauthorized use or restrict the layers of accessible information. Also in a personal terminal that assumes use by a single user, input of identification information such as a password is requested in order to detect impersonation by a third party. Such identification information is generally a combination of numerals. As a means for inputting identification information, a ten-key pad that is easy to use and has an easy apparatus configuration is in widespread use.

Identification information input unit using a ten-key pad employs a method of temporarily displaying input identification information and letting the user check identification information displayed then validate the identification information to be input. This process involves a risk of leaking important identification information to a third party since such identification information is displayed for checkup by the user. Another choice is an alternative display using symbols such as asterisks instead of direct display of identification information. The user cannot check input identification information via an alternative display in case identification information is rather long.

A ten-key pad includes a plurality of keys, typically 12 keys, arranged thereon. Considering usability, a ten-key pad can be reduced to only a certain size. In order to install a ten-key pad, a certain area must be provided. Further, such a ten-key pad occupies a considerable area since a window for displaying identification information is necessary. In terms of downsizing the apparatus and easier operation, it is difficult to select identification information input unit using a ten-key pad as a first choice.

### SUMMARY OF THE INVENTION

The invention has been proposed in view of the aforementioned circumstances and aims at providing identification information input apparatus that prevents leakage of identification information during data input and can be installed in a small occupied area.

The first aspect of the invention is identification information input apparatus for inputting identification information, characterized in that the apparatus comprises at least one dial unit (rotary encoder group 101) for giving the user a click feel per unit rotation and generating an electric signal, and inputting arbitrary alphanumeric characters constituting alphanumeric characters assigned in proportion to the number of rotations via rotating operation, a confirmation unit (pushbutton switch group 102) for confirming alphanumeric characters input via the dial unit, a conversion unit (password conversion unit 103, conversion table 104) for converting the electric signal generated by the dial unit to the alphanumeric characters, and authentication unit (password authentication unit 105) for authenticating the converted alphanumeric characters by checking whether the alphanumeric characters converted by the conversion unit are alphanumeric characters constituting the identification information. This aspect of the invention uses a dial input mechanism that allows the user to input identification information with a click feel, not via visual check. This ensures that identification information is not leaked while the user is inputting identification information.

The second aspect of the invention is identification information input apparatus for inputting identification information, characterized in that the conversion unit has a conversion table for specifying a procedure for converting an electric signal generated by the dial unit to corresponding alphanumeric characters, and performs conversion in accordance with the procedure written in the conversion table. Via this aspect of the invention, it is possible to select object-based conversion or minute operations by storing a conversion procedure in a conversion table.

The third aspect of the invention is identification information input apparatus for inputting identification information, characterized in that the confirmation unit confirms alphanumeric characters input via the dial unit by rotating the dial unit in reversed direction. Via this aspect of the invention, the feature of confirmation unit is provided in dial unit so that the user can perform input operation and confirmation operation with one hand. By integrating a plurality of features, it is possible to downsize the apparatus.

The fourth aspect of the invention is identification information input apparatus for inputting identification information, characterized in that the confirmation unit confirms alphanumeric characters input via the dial when the rotation direction of the dial unit is reversed and alternately changes the rotation direction of the dial unit and sequentially inputs each digit of the identification information. Via this aspect of the invention, the feature of confirmation unit is provided in dial unit so that the user can perform input operation and confirmation operation with one hand. By integrating a plurality of features, it is possible to downsize the apparatus.

The fifth aspect of the invention is identification information input apparatus for inputting identification information, characterized in that the apparatus comprises input cancellation unit for canceling input operation while inputting the digits of the identification information. Via this aspect of the invention, it is possible to cancel input operation. Thus it is possible to return to the initial state and restart input operation even in case input error was committed.

The sixth aspect of the invention is identification information input apparatus for inputting identification information, characterized in that the apparatus has unit for displaying the level of the user and performs display corresponding to the user level according to the input password. Via this aspect of the invention, it is possible to specify the security level of the user for the installed apparatus and limit the operation range in accordance with the security level of the user.

### BRIEF DESCRIPTION OF THE DRAWINGS

FIG. 1 is a block diagram showing identification information input apparatus according to an embodiment of the invention;

FIG. 2 shows double-phase pulse trains output by the rotary encoder;

FIG. 3 shows the password input process example 1 according to an embodiment of the invention;

FIG. 4 shows the password input process example 2 according to an embodiment of the invention;

FIG. 5 shows the password input process example 3 according to an embodiment of the invention;

FIG. 6 shows the password input process example 4 according to an embodiment of the invention;

FIG. 7 shows the password input process example 5 according to an embodiment of the invention.

### DETAILED DESCRIPTION OF THE PREFERRED EMBODIMENT

An embodiment of the invention will be described referring to the drawings.

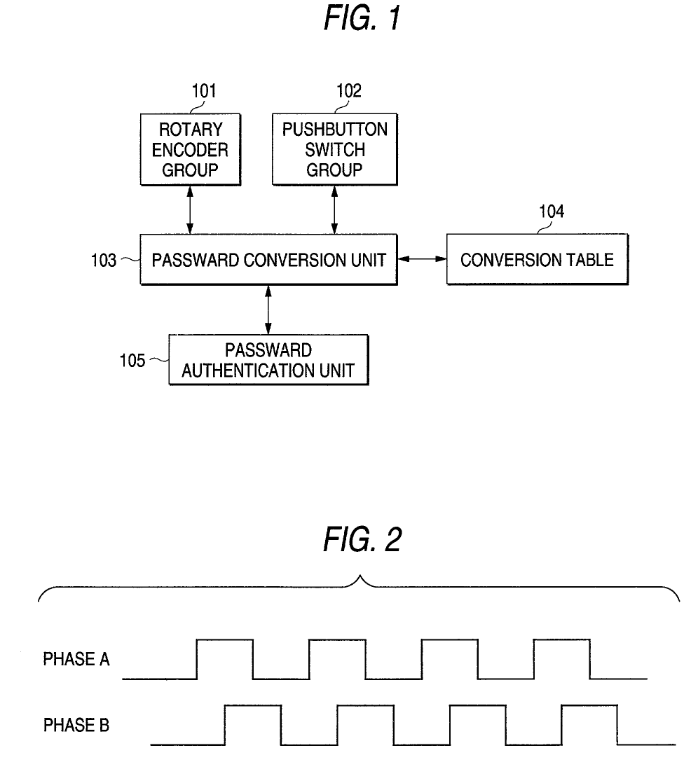

FIG. 1 shows an embodiment of the invention. In FIG. 1, identification information input apparatus of the invention comprises one or more rotary encoder groups 101, a switch group 102 as a confirmation unit, e.g., a pushbutton-type switch input, a conversion unit l03 for converting an electric signal generated by the rotary encoder group 101 and a switch group 102 to input alphanumeric characters, a conversion table 104 for describing the conversion process of the conversion unit 103, and a password authentication unit for authenticating that alphanumeric characters obtained as a conversion result of the conversion unit 103 constitute a password.

The rotary encoder 101 is a device used in a dial input mechanism, and may be based on the optical system, brush system, electromagnetic system or electrostatic system, so long as the rotary encoder generates an electric signal per unit rotation angle. While an incremental rotary encoder for generating a single pulse per unit rotation angle is assumed in the following description, the same embodiment may be configured by using an absolute rotary encoder for outputting an absolute value of rotation angle.

An incremental rotary encoder generally outputs double-phase pulse trains having a phase difference of 90 degrees in accordance with rotation, in order to detect rotation direction. FIG. 2 shows double-phase pulse trains output by the incremental rotary encoder. Pulse trains having Phase A and Phase B have a phase difference of 90 degrees in respect to the rotation angle. By detecting which pulse appears first, it is possible to detect the rotation direction of the rotary encoder.

In order to input data without relying on the visual sense in password input, a dial input mechanism has a mechanism for giving the user a click feel per unit rotation angle. While such a mechanism may issue a click tone, a process is preferable where stop positions are provided per unit rotation angle via a mechanical structure and a click feel is transmitted to a finger rotating the dial. In case a mechanical click feel and a click tone are used together, it is desirable to be able to suppress the click tone according to the use conditions via a switch provided separately or else.

In this embodiment a general pushbutton switch is used for the switch group 102. Especially, in case a single dial is used to perform password input, a dial input mechanism is provided with a mechanism for pressing in a direction parallel with the dial rotating face and arranging a pushbutton switch on the tip of the pressing mechanism. This permits character input by rotating the dial and switch input by pressing the dial horizontally. Via this configuration, compact installation is allowed suitable for a case where input operation is perform with one hand, without using the visual sense. The switch group 102 may be configured by a pushbutton switch or a snap switch. The switch group 102 may be configured by a mechanical switch or an electronic switch such as a contact switch. As the switch group 102, a switch feature added to the input mechanism may be used as mentioned earlier. Also, the switch mechanism may be detached from the input mechanism and an encoder group 101 as one or more input mechanisms and a switch group 102 as one or more switch mechanisms may be provided.

Alphanumeric characters that may be input from a dial input mechanism may be arbitrary alphanumeric character sets such as alphabetic characters and numerals. In order to perform input without using the visual sense, an ordered alphanumeric character set must be used, and a method of using numerals 0 through 9 is preferred in terms of usability. For example, by advancing an input numerical value per rotation angle starting with 1 and reaching 0 in the tenth click, it is possible to input a numeral corresponding to the number of clicks. The incremental rotary encoder must set a start point for counting the number of pulses before inputting alphanumeric characters. The absolute rotary encoder need not set a start point since the absolute value of rotation angle is output. For the absolute rotary encoder, the rotation angle absolutely corresponds with an input alphanumeric character. Thus, by rotating the dial from the preset start point, it is possible to input an alphanumeric character corresponding to the rotation angle of the dial.

In an aforementioned embodiment, a confirmation unit is needed for confirming an input alphanumeric character in each digit of password input. This unit is implemented via a rotary encoder and/or a switch. An input correction method is also needed that uses a unit for canceling input errors while inputting each digit.

The password conversion unit 103 converts pulses generated by the rotary encoder group 101 and the pushbutton switch group 102 to a password input alphanumeric character based on the conversion table 104. In case an absolute rotary encoder is used, the value of the encoder is a alphanumeric character since the rotation angle corresponds with the alphanumeric character. On the other hand, in case an incremental encoder is used, the number of pulses corresponds with the alphanumeric character so that it is necessary to previously store the relationship between the number of pulses and the alphanumeric character. For the absolute encoder, the number of alphanumeric characters that can be input is confirmed by the rotation angles. For example, in case a single alphanumeric character corresponds to a rotation angle of 10 degrees, the number of alphanumeric characters that can be input is 36. For the incremental encoder, separate number of pulses are assigned to each alphanumeric character and the number of alphanumeric characters that can be input is theoretically infinite. For the absolute encoder, it is difficult to modify the relationship between encoder values and alphanumeric characters. For the incremental encoder, it is made easy to modify the relationship between encoder values and alphanumeric characters, by modifying the conversion table that specifies the relationship between encoder values and alphanumeric characters.

The password authentication unit 105 compares the password converted by the password conversion unit 103, that is, an input password, with a pre-registered password and authenticates the input password when the comparison revealed data match. A unit may be provided whereby the subsequent password input is rejected in case the comparison revealed data unmatch a predetermined count.

Approaches of inputting a password will be described. While the password is a five-digit numeral and the rotation direction of the dial to give input values is mainly clockwise, this is not the sole configuration but the same advantage is obtained by changing the rotation direction of the dial to counterclockwise.

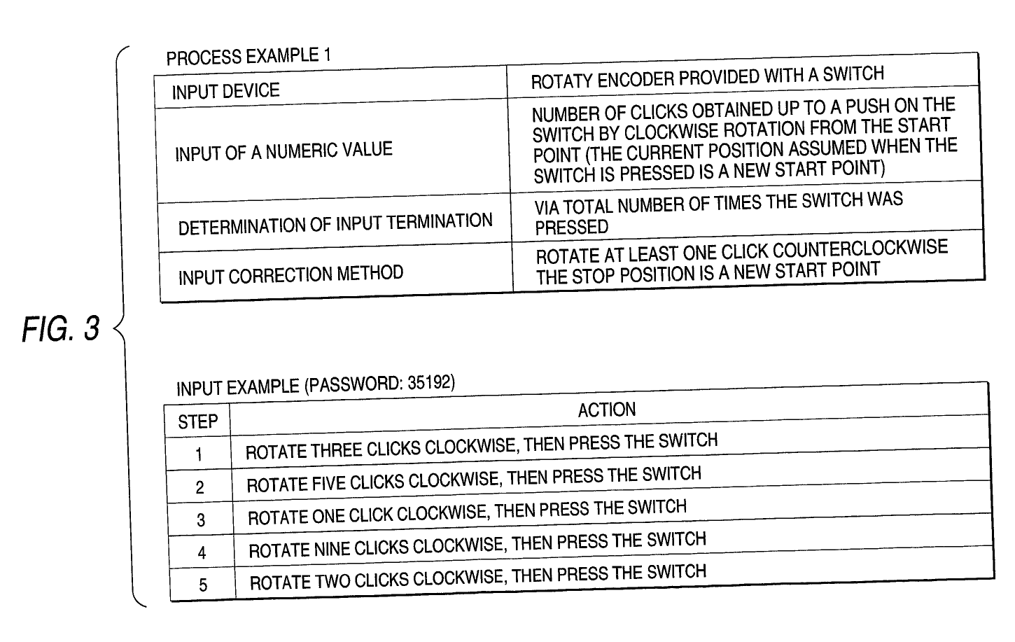

The password input process example 1 shown in FIG. 3 is an implementation example using a dial input mechanism provided with a switch. When the user is requested to input a password before operation via a separate unit or operation on the apparatus, the number of clicks obtained by rotating the dial clockwise from the dial position is the input value. As a confirmation unit, a switch attached to the dial input mechanism is used. By pressing the dial, the attached switch operates to confirm an input alphanumeric character.

When the switch is pressed to confirm the input alphanumeric character, that position is used as a new start point. Input of the next digit is the number of clicks obtained by rotating the dial clockwise from the new start point. In this way, sequentially confirming input characters in the digits thus confirming five-digit input alphanumeric characters or five numerals terminates password input. This password is authenticated by the password authentication unit 105.

In the process example 1, no features are provided for counterclockwise rotation of the dial. The input feature is set to the clockwise rotation of the dial alone. The counterclockwise rotation of the dial may be used as input cancellation unit. That is, in case the dial is rotated too far clockwise in the input of a digit, the input is canceled by rotating the dial counterclockwise. The dial is rotated counterclockwise and stops at a new start point, from which the dial is rotated clockwise to obtain the number of clicks to be input.

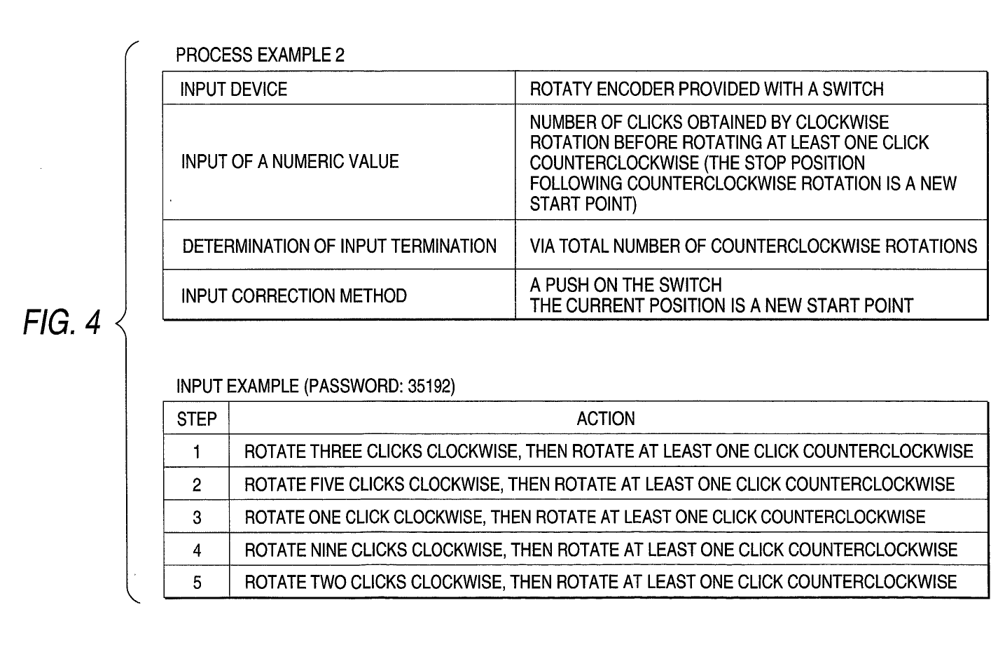

The process example 2 of password input shown in FIG. 4 is an example using a dial input mechanism provided with a switch. In this example, counterclockwise rotation of the dial and use of the switch are opposite to those in the process example 1. That is, counterclockwise rotation of the dial is used as confirmation unit and the switch attached to the dial input mechanism is used as input cancellation unit. When input of a password is requested, the dial is rotated clockwise to obtain a desired number of clicks, and the dial is rotated at least one click counterclockwise to confirm the input character. Input characters in the five digits are sequentially confirmed, and the fifth counterclockwise rotation terminates input of a password.

In case the dial is rotated too far clockwise, the input is canceled by pressing the dial thus operating the attached switch. The then position of the dial is used as a new start point, from which the dial is rotated clockwise to obtain the number of clicks to be input.

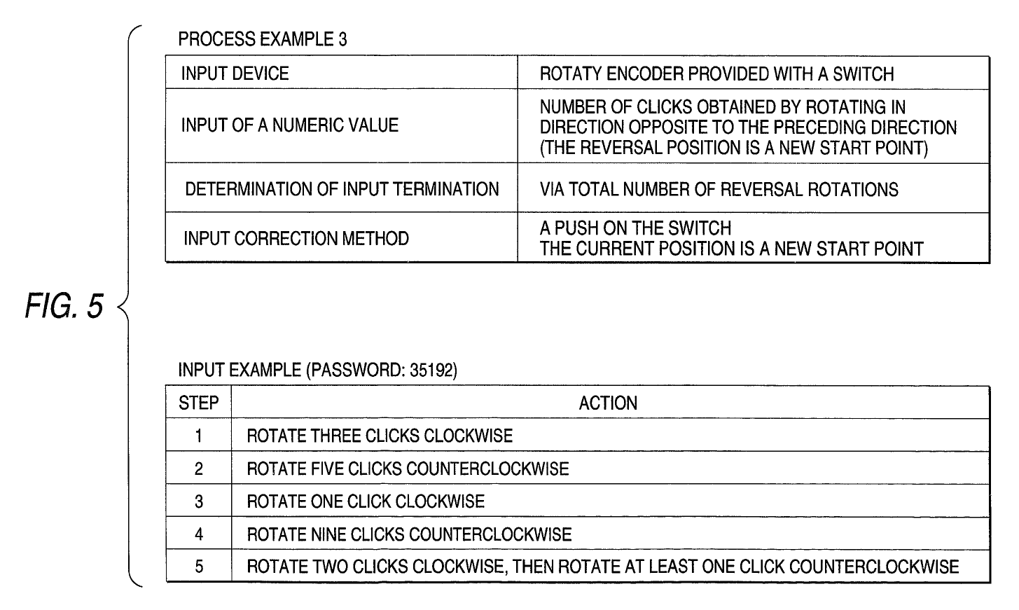

The process example 3 of password input shown in FIG. 5 is an example using a dial input mechanism provided with a switch, where reversal of rotation direction of the dial is used as confirmation unit. The switch attached to the dial input mechanism is used as input cancellation unit. When input of a password is requested, the dial is rotated clockwise to obtain the number of clicks for the first digit, then counterclockwise to obtain the number of clicks for the second digit. Input character for the first digit is confirmed by rotating the dial counterclockwise for input of the second digit. In this way, input characters for the digits are successively confirmed by alternating the clockwise and counterclockwise dial rotations. By alternating the dial rotation directions after obtaining the number of clicks in the fifth digit, password input is complete.

In case the dial is rotated too far while a password is input, the input is canceled by pressing the dial thus operating the attached switch. The then position of the dial is used as a new start point, from which the dial is rotated in a proper direction to obtain the number of clicks to be input.

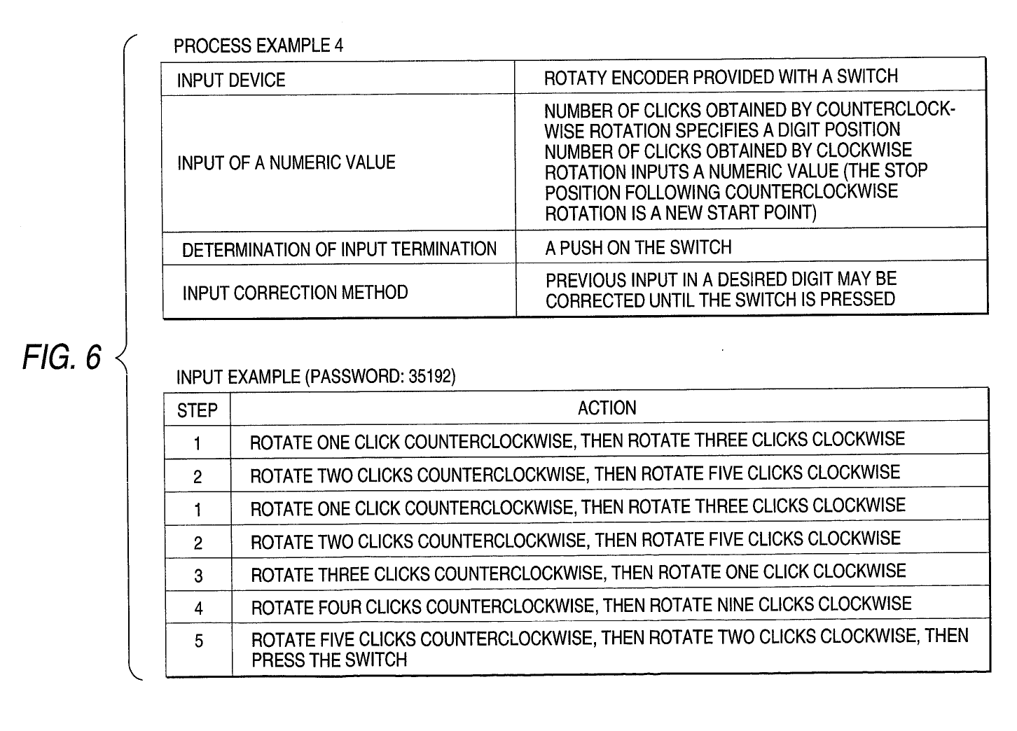

The process example 4 of password input shown in FIG. 6 is an example using a dial input mechanism provided with a switch. In this example, the number of clicks in the counterclockwise rotation of the dial specifies the digit position of a password, then the subsequent number of clicks in clockwise rotation of the dial gives an input numeric value. The confirmation unit is counterclockwise rotation of the dial. It is possible to specify the digit positions already input via counterclockwise rotation of the dial. This makes it possible to correct the input in a desired digit position. Finally, by pressing the dial, the attached switch operates to confirm the password input.

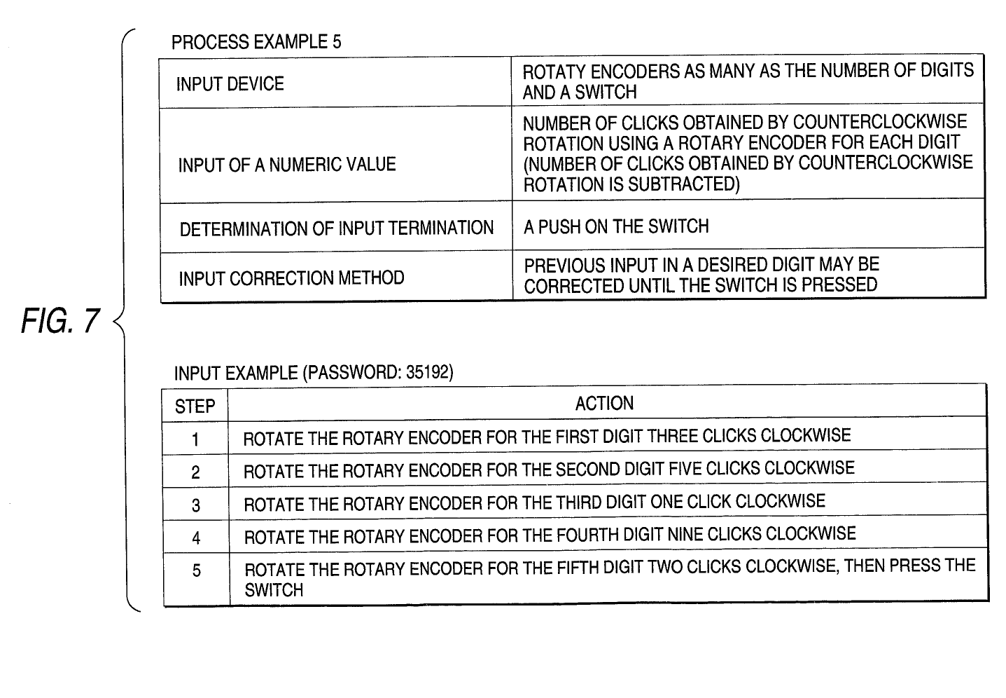

The process example 5 of password input shown in FIG. 7 is an example where a dial input mechanism corresponding to the number of digits are provided. In this example, dial setting for each digit is properly specified as in the process examples 1 through 4, then a pushbutton switch for terminating the input is pressed to confirm the password input. Another process may be used where a dial input mechanism provided with a switch is used and a dial is pressed each time input to a digit is made, then the password input is confirmed by determining that the dial has been pressed for all the digits. Another configuration is possible where an LED to blink each time input to a digit is made, and the LED shifts from blinking to lighting when password input is confirmed. In the process example 5, it is made easy to add a feature to work for each digit and a feature to work for all the digits by providing a plurality of dial input mechanisms. For example, to cancel input data, in case a digit is left unspecified for a predetermined time, operation on the corresponding digit and/or all the digits is canceled. In case the switch is operated once, operation on the corresponding digit is canceled. In case the switch is operated twice, operation on all the digits is canceled.

As well as the input cancellation methods as described in the aforementioned process examples, it is possible to cancel the input in case the dial is rotated at least 10 clicks and arrange the input numeric values per unit rotation angle in the reversed order, that is, 0, 9, 8, 7, 6, 5, 4, 3, 2, 1 in case the switch is pressed to confirm input in each digit, as in the process example 1.

In the input method also, it is possible to associate clockwise rotation of the dial with an increase in the numeric value, and counterclockwise rotation of the dial with a decrease in the numeric value. Further, start points may be set for both directions and separate start points may be used for each digit to input alphanumeric characters. To change the start point, for example, the clockwise start point is set at a predetermined number of clicks from the counterclockwise start point. In this case, in order to inhibit an increase/decrease in the counterclockwise (clockwise) direction from the counterclockwise (clockwise) start point, a click feel does not occur in case the dial is rotated in an inhibited direction.

In the aforementioned embodiment, it is possible to select an process by using the conversion table 104 depending on the object. For example, it is possible to store a variety of aforementioned processes and partially modified processes thereof in the conversion table 104 that stores the procedure for the conversion method used by the password conversion unit 103, and select an object-based process by specifying a desired process via a separate method, or select minute operations.

It is possible to determine the security level per user and display the security level of the user when a password is input and authenticated.

As described earlier, according to the invention, it is possible to provide identification information input apparatus with excellent usability that can be installed in a small space without using a related art ten-key pad, by using dial unit provided with a dial input mechanism. Further, the user can identify the input alphanumeric characters based on the click feel generated in accordance with the operation of the dial unit, without using the visual sense. This eliminates the need for externally displaying the input information as in the related art, thereby preventing the risk of data leakage to a third party.

What is claimed is:

1. Identification information input apparatus for inputting identification information, comprising:
a dial unit for inputting arbitrary alphanumeric characters via rotating operation and generating an electric signal, wherein the alphanumeric characters is assigned in proportion to rotation angle of the dial unit via rotating operation, and wherein the dial unit gives the user a click feel per unit rotation;
a confirmation unit for confirming alphanumeric characters input via the dial unit;
a conversion unit for converting the electric signal generated by the dial unit to the alphanumeric characters; and
an authentication unit for authenticating the converted alphanumeric characters by checking whether the alphanumeric characters converted by the conversion unit matches alphanumeric characters forming the identification information.

2. Identification information input apparatus according to claim 1,
wherein the conversion unit includes a conversion table for specifying a procedure for converting an electric signal generated by the dial unit to corresponding alphanumeric characters, and performs conversion in accordance with the procedure written in the conversion table.

3. Identification information input apparatus according to claim 1,
wherein the confirmation unit confirms alphanumeric characters input via the dial unit by rotating the dial unit in reversed direction.

4. Identification information input apparatus according to claim 1,
wherein the confirmation unit confirms alphanumeric characters input via the dial when the rotation direction of the dial unit is reversed and alternately changes the rotation direction of the dial unit and sequentially inputs each digit of the identification information.

5. Identification information input apparatus according to claim 1, further comprising an input cancellation unit for canceling input operation while inputting the digits of the identification information.

6. Identification information input apparatus according to claim 1, further comprising a display unit for displaying the level of the user and performs display corresponding to the user level according to the input password.
